(19) United States
(12) Patent Application Publication
(10) Pub. No.: US 2026/0335848 A1
(43) Pub. Date: Oct. 29, 2026

(54) STIRRING BLADE AND STIRRING DEVICE

(71) Applicant: MITSUBISHI HEAVY INDUSTRIES, LTD., Tokyo (JP)

(72) Inventors: Shunsuke TABA, Tokyo (JP); Takashi OKAFUJI, Tokyo (JP); Kenji YAGI, Tokyo (JP); Keiichi NAKAGAWA, Tokyo (JP); Keiji FUJIKAWA, Tokyo (JP)

(73) Assignee: MITSUBISHI HEAVY INDUSTRIES, LTD., Tokyo (JP)

(21) Appl. No.: 19/485,338

(22) PCT Filed: Jan. 29, 2024
(86) PCT No.: PCT/JP2024/002546

§ 371 Date: Nov. 18, 2025

(30) Foreign Application Priority Data
Jun. 22, 2023 (JP) 2023-102379

(51) Int. Cl. B01F 35/212; B01F 27/70; B01F 35/214; G01L 5/00

(52) U.S. Cl. CPC B01F 35/212; B01F 27/70; B01F 35/214; G01L 5/0028

(57) ABSTRACT

A stirring blade is a stirring blade including a support, and a blade provided at the support, the support being a cylindrical support having a first cavity portion formed inside thereof, the stirring blade including one or more strain gauges attached to an inner surface defining the first cavity portion and data logger installed inside the first cavity portion and electrically connected to each of the one or more strain gauges.

### TECHNICAL FIELD

The disclosure relates to a stirring blade and a stirring device.

The present application claims priority based on JP 2023-102379 filed with the Japanese Patent Office on Jun. 22, 2023, the contents of which are incorporated herein by reference.

### BACKGROUND ART

From the viewpoint of designing a stirring blade for stirring contents fed into a stirring container, it is required to measure strain generated in the stirring blade while the contents are stirred and a load received by the stirring blade while the contents are stirred.

Patent Document 1 discloses a heat-resistant case that protects a measurement device that measures a physical state of a workpiece. The heat-resistant case is configured of a waterproof and heat-insulating case and an outer case, and a heat insulating material is packed in the waterproof and heat-insulating case. An internal space is formed inside the heat insulating material, and a measurement device main body is accommodated in the internal space. Although a sealing material is disposed between a lid of the waterproof and heat-insulating case and the container to keep watertightness of the heat-insulating case, a cable connecting the device main body (for example, a data logger) and a probe such as a strain gauge extends from the internal space of the waterproof and heat-insulating case. Note that a periphery of the cable is also sealed with the sealing material.

### CITATION LIST

### Patent Document

Patent Document 1: JP 5110010 B

### SUMMARY OF INVENTION

### Technical Problem

However, in the example of the related art illustrated in Patent Document 1, since the cable extends from the internal space of the waterproof and heat-insulating case, even in a case where the periphery of the cable is sealed with a sealing member, when applied to a stirring blade, there is a risk that the contents hit the cable and the cable (lead wire) is disconnected by stirring the contents.

The disclosure has been made in view of the above-described problem, and an object thereof is to provide a stirring blade with which a risk of disconnection of a lead wire electrically connecting a strain gauge to a data logger can be reduced.

### Solution to Problem

In order to achieve the above object, a stirring blade according to the disclosure is a stirring blade including
a support, and
a blade provided at the support,
the support being a cylindrical support having a first cavity portion formed inside thereof, the stirring blade including
one or more strain gauges attached to an inner surface defining the first cavity portion, and
a data logger installed inside the first cavity portion and electrically connected to each of the one or more strain gauges.

### Advantageous Effects of Invention

According to a stirring blade of the disclosure, since one or more strain gauges attached to an inner surface defining a first cavity portion is electrically connected to a data logger installed inside the first cavity portion, a lead wire electrically connecting the strain gauges to the data logger is accommodated in the first cavity portion. This prevents contents from hitting the lead wire while the contents are stirred, and thus a risk of disconnection of the lead wire can be reduced.

### BRIEF DESCRIPTION OF DRAWINGS

FIG. 1 is a vertical cross-sectional view schematically illustrating a configuration of a stirring device according to one embodiment.

FIG. 2 is a horizontal cross-sectional view of the stirring device taken along line II-II in FIG. 1.

FIG. 3 is a vertical cross-sectional view schematically illustrating a configuration of a stirring blade according to a first embodiment.

FIG. 4 is a vertical cross-sectional view schematically illustrating a configuration of a stirring blade according to a second embodiment.

FIG. 5 is a vertical cross-sectional view schematically illustrating a configuration of a stirring blade according to a third embodiment.

FIG. 6 is a diagram illustrating a strain gauge attached to a support of a stirring blade according to a fourth embodiment.

FIG. 7 is a diagram illustrating two strain gauges attached to different positions in an axial direction of a support of a stirring blade according to a fifth embodiment, and a position of a load point.

FIG. 8 is a vertical cross-sectional view schematically illustrating a configuration of a stirring blade according to a sixth embodiment.

FIG. 9 is a vertical cross-sectional view schematically illustrating a configuration of a stirring blade according to a seventh embodiment.

FIG. 10 is a diagram illustrating a battery box fixed to an outside of a support of a stirring blade according to an eighth embodiment.

FIG. 11 is a diagram illustrating a battery box fixed to an outside of a support of a stirring blade according to a ninth embodiment.

FIG. 12 is a diagram illustrating an antenna line accommodated in a battery box fixed to an outside of a support of a stirring blade according to a tenth embodiment.

FIG. 13 is a diagram schematically illustrating a configuration of a stirring blade according to an eleventh embodiment.

FIG. 14 is a diagram schematically illustrating a configuration of a stirring device according to one embodiment.

FIG. 15 is a diagram illustrating a stirring device according to one embodiment in which a power supply box is fixed to a support or a rotor shaft so that the power supply box is located behind the support of a stirring blade in a rotational direction of the stirring blade.

FIG. 16 is a diagram illustrating a stirring device according to one embodiment in which a power supply box includes a curved surface at a part of an outer surface thereof.

### DESCRIPTION OF EMBODIMENTS

Hereinafter, a stirring blade and a stirring device according to embodiments will be described with reference to the attached drawings.

However, the dimensions, materials, shapes, relative arrangements, or the like of the components described as embodiments or illustrated in the drawings are not intended to limit the scope of the present invention but are merely illustrative examples.

### Configuration of Stirring Device According to One Embodiment

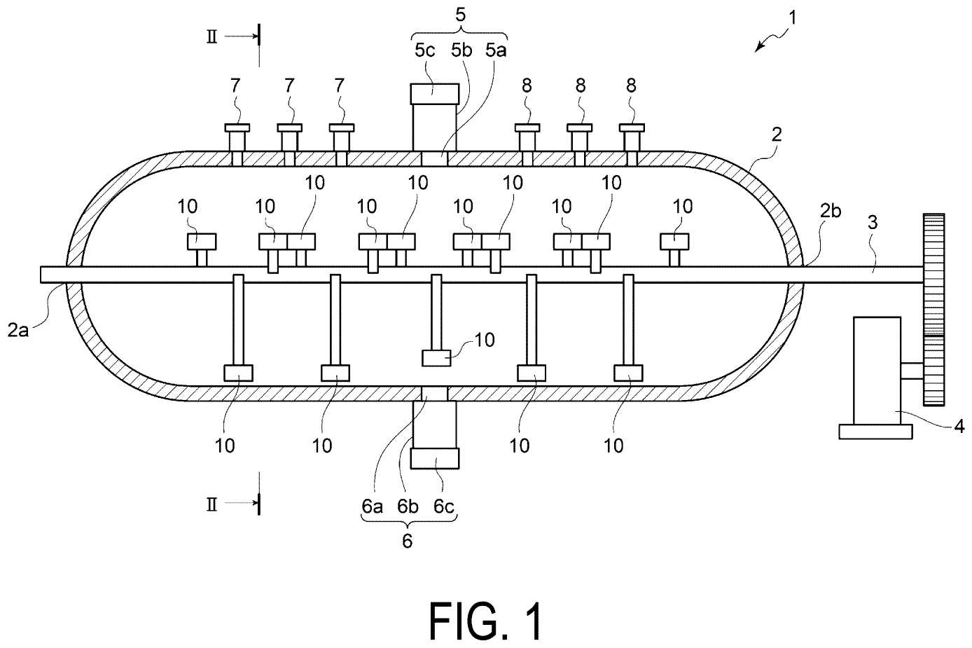

As illustrated in FIG. 1, a stirring device 1 according to one embodiment includes a stirring container 2 having a shape elongated in a horizontal direction, a rotor shaft 3 provided so as to penetrate the stirring container 2 in the horizontal direction, and one or more stirring blades 10 fixed to the rotor shaft 3. A configuration is adopted in which the rotor shaft 3 can be rotated by a motor 4 being a rotation device. The motor 4 is preferably configured to be capable of switching a rotational direction of the rotor shaft 3. That is, the motor 4 preferably includes a switching device that switches the rotational direction of the rotor shaft 3. The switching device may be, for example, a device that reverses a current flowing through the motor 4 in order to reverse a rotational direction of the motor 4, or may be a device that reverses a direction of rotation transmitted from the motor 4 to the rotor shaft 3.

### Configuration of Stirring Container of Stirring Device According to One Embodiment

The stirring container 2 is provided with a feed port 5 for feeding contents to be stirred by the stirring device 1 into the stirring container 2, and a discharge port 6 for discharging the contents in the stirring container 2 from the stirring container 2. The feed port 5 includes a feed hole 5a formed at the stirring container 2, a feed cylinder 5b in a cylindrical shape having one end connected to the stirring container 2 so as to surround the feed hole 5a, and an opening/closing member 5c such as a lid or a valve that opens and closes an opening at another end of the feed cylinder 5b. The discharge port 6 includes a discharge hole 6a formed at the stirring container 2, a discharge cylinder 6b in a cylindrical shape having one end connected to the stirring container 2 so as to surround the discharge hole 6a, and an opening/closing member 6c such as a lid or a valve that opens and closes an opening at another end of the discharge cylinder 6b. Although the feed port 5 and the discharge port 6 are illustrated in FIG. 1 as being located at the same position in the horizontal direction, these ports may be provided at different positions in the horizontal direction.

Note that the stirring device 1 is not limited to a device that simply stirs and mixes contents, and may be a reactor in which a chemical reaction occurs. When the stirring device 1 is a reactor, a jacket constituting a path through which liquid or a steam heat medium flows may be provided at an outer surface of the stirring container 2 in order to adjust a temperature in the stirring container 2.

Further, the stirring device 1, which is a reaction device, may be a hydrothermal treatment device for hydrolyzing waste as contents. In this case, as illustrated in FIG. 1, the stirring container 2 is provided with a supply port 7 for supplying steam into the stirring container 2 and an exhaust port 8 for exhausting gas in the stirring container 2 from the stirring container 2. Although three of the supply ports 7 and three of the exhaust ports 8 are provided in FIG. 1, the number of these ports may be optionally changed.

### Configuration of Stirring Blade 10 of Stirring Device 1 According to One Embodiment

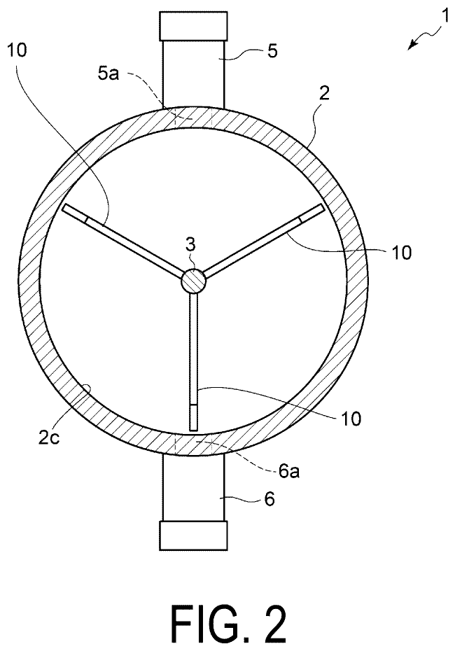

As illustrated in FIG. 2, the plurality of stirring blades 10 are disposed such that the plurality of stirring blades 10 appear to be divided into a plurality of groups when the plurality of stirring blades 10 are viewed in a length direction of the rotor shaft 3, and the respective groups extend in a plurality of different directions in a circumferential direction around the rotor shaft 3. Hereinafter, a configuration of the one or more stirring blades 10 (10A to 10K) fixed to the rotor shaft 3 will be described.

### First Embodiment

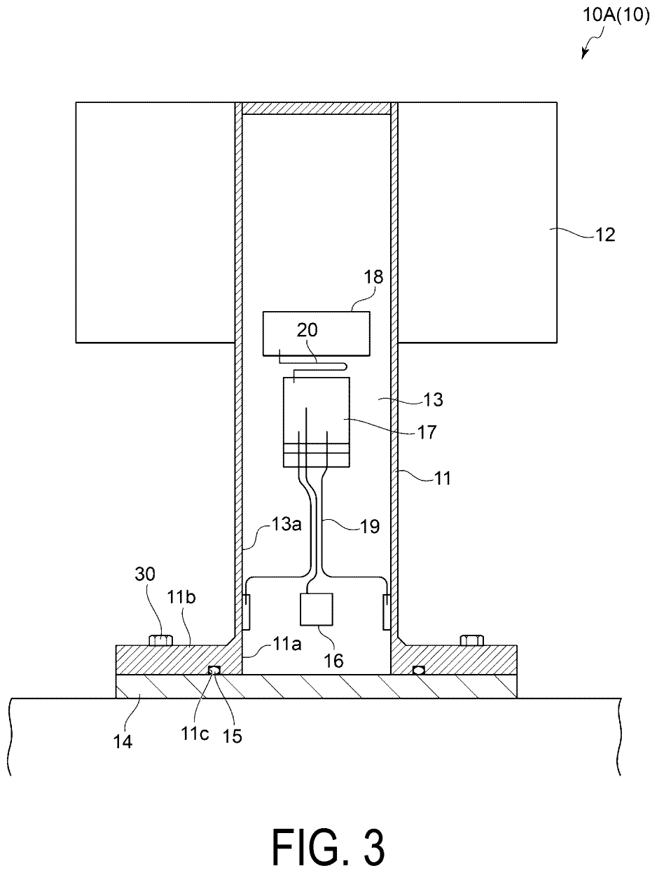

As illustrated in FIG. 3, the stirring blade 10A according to a first embodiment includes a support 11 and a blade 12 provided at the support 11.

The support 11 is the support 11 in a cylindrical shape having a first cavity portion 13 formed inside thereof. The support 11 is preferably made of metal and a thickness of a portion in a cylindrical shape is constant, but the thickness need not be constant. The support 11 has, for example, a rectangular cross-section, but is not limited thereto, and may have any shape, in addition to a circular shape. The support 11 is formed of, for example, a square pipe made of stainless steel having a square cross-section and a constant thickness, and the first cavity portion 13 is defined by closing both end openings of the square pipe.

An opening 11a communicating with the first cavity portion 13 is formed at one end portion (base end portion) of the support 11. A flange 11b surrounding the opening 11a is provided around the opening 11a. The opening 11a is closed by a lid member 14 having the same size as the flange 11b, and the flange 11b and the lid member 14 are fastened together to the rotor shaft 3 by a fastening member 30, thereby being fixed to the rotor shaft 3. An endless groove 11c surrounding the opening 11a is provided at a surface of the flange 11b facing the lid member 14. An O-ring 15 is fitted into the groove 11c, and the flange 11b and the lid member 14 are fastened together to the rotor shaft 3, so that the O-ring 15 is crushed and airtightness of the first cavity portion 13 is ensured.

The blade 12 is provided so as to intersect with a height direction of the support 11. The blade 12 is preferably provided on one end portion (tip portion) side of the support 11 side, and for example, can be provided such that a tip of the support 11 coincides with a tip of the blade 12.

The stirring blade 10A includes one or more strain gauges 16 attached to an inner surface 13a defining the first cavity portion 13, a data logger 17 installed inside the first cavity portion 13 and electrically connected to each of the one or more strain gauges 16, and a power supply 18 electrically connected to the data logger 17. The power supply 18 is, for example, a battery, and is installed inside the first cavity portion 13 together with the data logger 17, but may be installed outside the first cavity portion 13.

The one or more strain gauges 16 are attached to the inner surface 13a facing a direction of a load acting on the support 11. For example, when measuring strain generated in the base end portion of the support 11 by a load acting on the tip portion of the support 11, the attachment is performed such that a strain measurement direction of the one or more strain gauges 16 is aligned with an axial direction of the support 11. When a cross-section of the support 11 is rectangular, the strain gauge 16 is attached to at least one of two surfaces facing each other in a rotational direction among the four inner surfaces 13a defining the first cavity portion 13, but the disclosure is not limited thereto, and the strain gauge 16 may be attached to each of the four inner surfaces 13a as in the example of FIG. 3. The inner surface 13a to which the one or more strain gauges 16 are attached is preferably smooth, and is degreased with acetone or the like, and then the one or more strain gauges 16 are attached to the inner surface 13a with an adhesive. Each of the one or more strain gauges 16 is connected to the data logger 17 by a lead wire 19, so that the data logger 17 is electrically connected to each of the strain gauges 16.

The data logger 17 is fixed to the inner surface 13a of the first cavity portion 13 by, for example, fixing a mounting bracket to the inner surface 13a of the first cavity portion 13 and fixing the data logger 17 to the mounting bracket. The data logger 17 includes, for example, a bridge circuit for detecting a change in electric resistance of the strain gauge 16 along with deformation of the strain gauge 16, and records the change in the electric resistance of the strain gauge 16 detected by the bridge circuit or a strain amount obtained by converting the change in the electric resistance. The data logger 17 is connected to the power supply 18 by an electric wire 20, so that the power supply 18 is electrically connected to the data logger 17. Although FIG. 3 illustrates a form in which one data logger 17 is installed, the plurality of data loggers 17 may be installed depending on the number of strain gauges 16 attached to the inner surface 13a of the first cavity portion 13.

Further, the data logger 17 can be taken out from the first cavity portion 13 by removing the support 11 from the rotor shaft 3. To be more specific, by loosening the fastening member 30, the support 11 fixed to the rotor shaft 3 can be removed together with the stirring blade 10A. As a result, the lid member 14 fastened together with the flange 11b is also taken out from the flange 11b, and the opening 11a appears. Thus, the data logger 17 accommodated in the first cavity portion 13 can be taken out to an outside of the support 11 through the opening 11a. Note that lengths of the lead wire 19 and the electric wire 20 are preferably large enough to take out the data logger 17 from the first cavity portion 13 without removing the lead wire 19 and the electric wire 20 from the data logger 17.

The stirring blade 10A according to the first embodiment is fixed to the rotor shaft 3 provided so as to penetrate the stirring container 2, and is rotated by the motor 4 being a rotation device. Thus, the stirring blade 10A stirs contents fed into the stirring container 2. At this time, the contents become a load to cause strain in the stirring blade 10A, and the strain gauge 16 attached to the stirring blade 10A (support 11) is also deformed. The change in the electric resistance of the strain gauge 16 along with the deformation of the strain gauge 16 or the strain amount obtained by converting the change in the electric resistance is recorded in the data logger 17.

The change in the electric resistance or the strain amount recorded in the data logger 17 in this manner can be acquired by removing the support 11 together with the stirring blade 10A from the rotor shaft 3 and taking out the data logger 17 after operation of the stirring device 1 is finished.

According to the stirring blade 10A according to the first embodiment, since the one or more strain gauges 16 attached to the inner surface 13a defining the first cavity portion 13 are electrically connected to the data logger 17 installed inside the first cavity portion 13, the lead wire 19 electrically connecting the strain gauge 16 to the data logger 17 is accommodated in the first cavity portion 13. This prevents the contents from hitting the lead wire 19 while the contents are stirred, and thus a risk of disconnection of the lead wire 19 can be reduced.

Further, since the data logger 17 can be taken out from the first cavity portion 13 by removing the support 11 from the rotor shaft 3, the change in the electric resistance or the strain amount obtained by converting the change in the electric resistance recorded in the data logger 17 can be acquired from the data logger 17 taken out. From the change in the electric resistance or the strain amount obtained by converting the change in the electric resistance taken out in this manner, a strain amount generated in the stirring blade 10A (support 11) while the contents are stirred can be considered. Then, a load acting on the stirring blade 10A (support 11) while the contents are stirred can be calculated from the strain amount.

### Second Embodiment

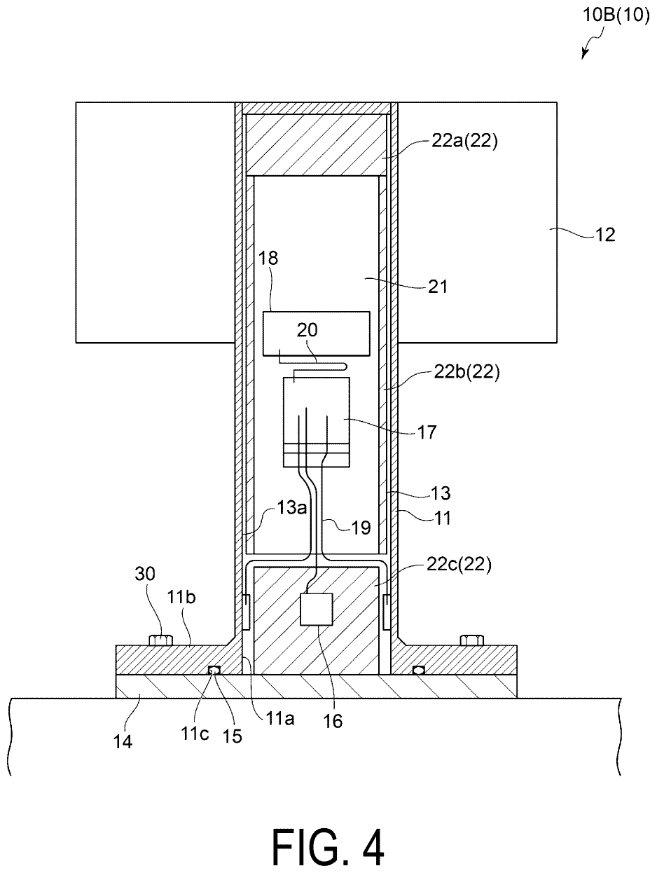

As illustrated in FIG. 4, the stirring blade 10B according to a second embodiment further includes a heat insulating material 22 fitted and accommodated in the first cavity portion 13. The heat insulating material 22 has a second cavity portion 21 in which the data logger 17 is accommodated being formed thereat. Other configurations are the same as those of the stirring blade 10A according to the first embodiment.

The heat insulating material 22 protects the data logger 17 from a high-temperature environment, and can keep a temperature in the second cavity portion 21 lower than a temperature in the stirring container 2. The heat insulating material 22 is configured by being divided into, for example, three blocks 22a, 22b, and 22c. The three blocks 22a, 22b, and 22c are configured with the blocks 22a and 22c that are solid and respectively fitted into one end portion side and another end portion side of the first cavity portion 13, and the block 22b that is cylindrical and sandwiched between the two blocks 22a and 22c, and the second cavity portion 21 is defined by closing a space provided at the cylindrical block 22b with the two blocks 22a and 22c.

The data logger 17 accommodated in the second cavity portion 21 is fixed to an inside of the second cavity portion 21, and the lead wire 19 connecting each of the one or more strain gauges 16 to the data logger 17 is wired so as to passing through, for example, between the block 22b and the block 22c constituting the heat insulating material 22.

According to the stirring blade 10B according to the second embodiment, even when the stirring blade 10B is used in a high-temperature environment, for example, as in a case where the stirring container 2 is a hydrolysis reactor or a chemical reactor, the data logger 17 is accommodated in the second cavity portion 21 provided at the heat insulating material 22 fitted and accommodated in the first cavity portion 13, and thus the data logger 17 is protected from the high-temperature environment, and a change in electric resistance along with deformation of the strain gauge 16 or a strain amount of the stirring blade 10B obtained by converting the change in the electric resistance can be recorded. Furthermore, even when the power supply 18 is poor in heat resistance, the power supply 18 is protected from a high-temperature environment by installing the power supply 18 inside the second cavity portion 21, and thus it is possible to supply power to the data logger 17.

### Third Embodiment

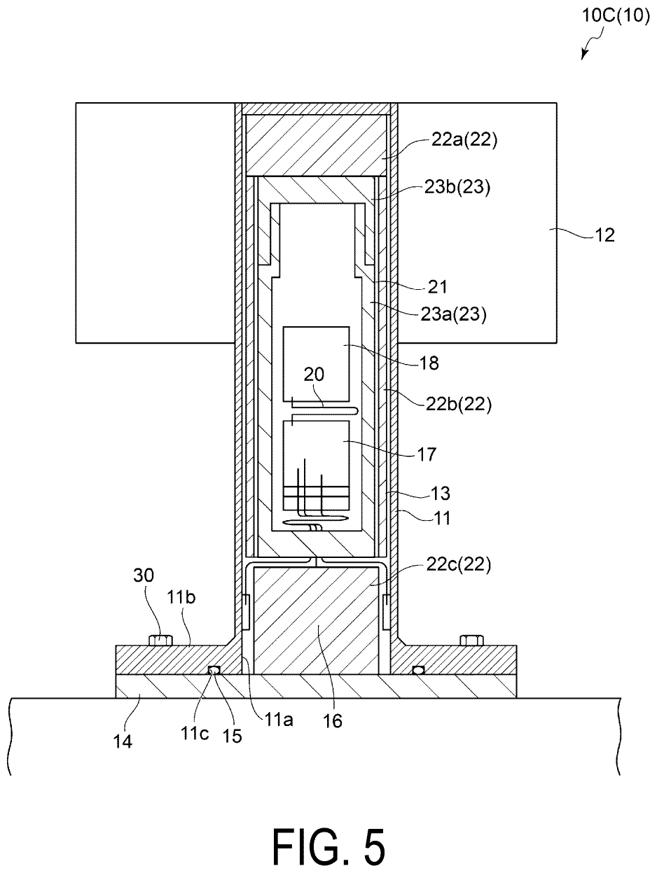

As illustrated in FIG. 5, the stirring blade 10C according to a third embodiment further includes a vacuum double container 23 fitted and accommodated in the second cavity portion 21. The data logger 17 and the power supply 18 are sealed in the vacuum double container 23. Other configurations are the same as those of the stirring blade 10B according to the second embodiment.

The vacuum double container 23 protects the data logger 17 and the power supply 18 from a further higher-temperature environment, has a higher heat insulating performance than that of the heat insulating material 22, and can keep a temperature in the vacuum double container 23 lower than a temperature in the second cavity portion 21. The vacuum double container 23 is configured with a container 23a and a lid 23b. The container 23a is configured with an inner container and an outer container made of metal, and a space between the inner container and the outer container is kept in a vacuum, thereby obtaining a high heat insulation property. The data logger 17 and the power supply 18 sealed in the vacuum double container 23 may be protected by a buffer material such as sponge packed in the vacuum double container 23 and fixed. Note that the data logger 17 can be taken out from the second cavity portion 21 together with the vacuum double container 23, and the length of the lead wire 19 is preferably large enough to take out the data logger 17 together with the vacuum double container 23.

According to the stirring blade 10C according to the third embodiment, a heat insulation effect is higher than that of the stirring blade 10B according to the second embodiment by a heat insulation effect of the vacuum double container 23, and thus the stirring blade 10C can protect the data logger 17 and the power supply 18 even when the stirring blade 10C is used under a higher-temperature environment as compared with the stirring blade 10B according to the second embodiment.

### Fourth Embodiment

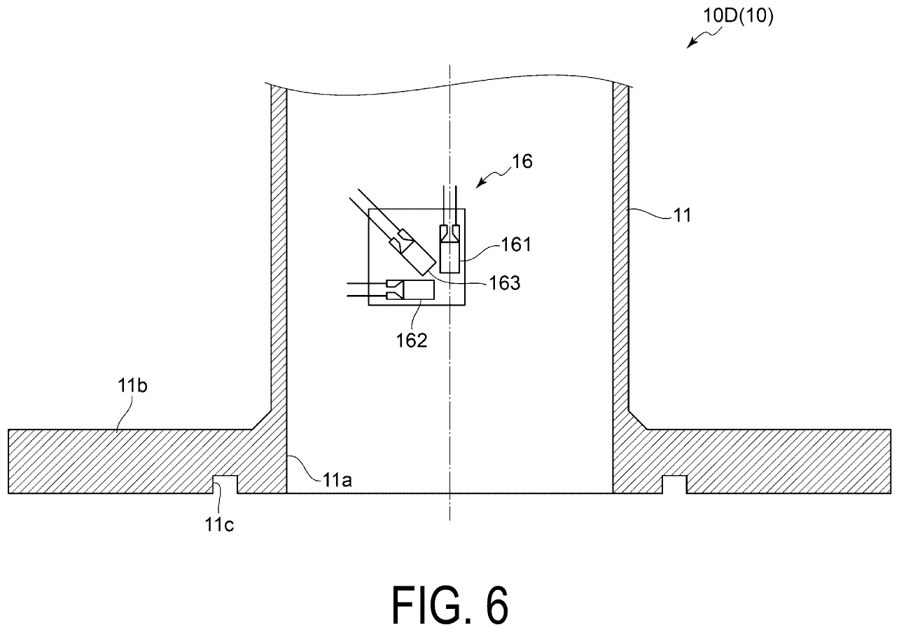

As illustrated in FIG. 6, in the stirring blade 10D according to a fourth embodiment, the one or more strain gauges 16 include a first strain measurement element 161, a second strain measurement element 162 provided along a direction orthogonal to the first strain measurement element 161, and a third strain measurement element 163 provided along a direction of 45 degrees with respect to the first strain measurement element 161 and the second strain measurement element 162, and the first strain measurement element 161 is attached along an axial direction of the support 11. Other configurations are the same as those of the stirring blades 10A, 10B, and 10C according to any one of the first to third embodiments.

The strain gauge 16 including the first strain measurement element 161, the second strain measurement element 162, and the third strain measurement element 163 in this manner is referred to as a triaxial strain gauge, and electric resistance of each strain measurement element changes along with deformation in a direction in which the strain measurement element is provided. Then, strain amounts in the respective directions are calculated by converting the respective changes in the electric resistance.

As described above, the first strain measurement element 161 is attached along the axial direction of the support 11, so that the second strain measurement element 162 is disposed along a direction orthogonal to the axial direction of the support 11, and the third strain measurement element 163 is disposed along a direction of 45 degrees with respect to the axial direction of the support 11 and the direction orthogonal to the axial direction.

According to the stirring blade 10D according to the fourth embodiment, strain in the axial direction of the support 11 is measured by the change in the electric resistance of the first strain measurement element 161, and strain in the direction orthogonal to the axial direction of the support 11 is measured by the change in the electric resistance of the second strain measurement element 162. Then, strain in the direction of 45 degrees with respect to the axial direction of the support 11 and the direction orthogonal to the axial direction is measured by the change in the electric resistance of the third strain measurement element 163.

When the strain in the axial direction of the support 11 is defined as εx, the strain in the direction orthogonal to the axial direction is defined as εy, the strain in the direction of 45 degrees with respect to the axial direction and the direction orthogonal to the axial direction is defined as εxy, a section modulus of the support 11 is defined as Z, a longitudinal elastic modulus of a material of the support 11 is defined as E, a transverse elastic modulus of the material of the support 11 is defined as G, a Poisson's ratio is defined as v, and a torsional coefficient of the support 11 is defined as K, a bending force Mbend can be calculated from the following Equation 1, and a torsional force Ttorque can be calculated from the following Equation 2.

$${M}_{bend} = \frac{ZE}{1 - {v}^{2}} ( {ε}_{x} + v {ε}_{y} ) \qquad [ Math . 1 ]$$

T_{torque}=GK(2ε_{xy}−ε_{y}−εₓ) [Math. 2]

This makes it possible to separate a vertical stress caused by the bending force on the support 11 from a shear stress caused by the torsional force, and to more accurately evaluate strength of the support 11.

### Fifth Embodiment

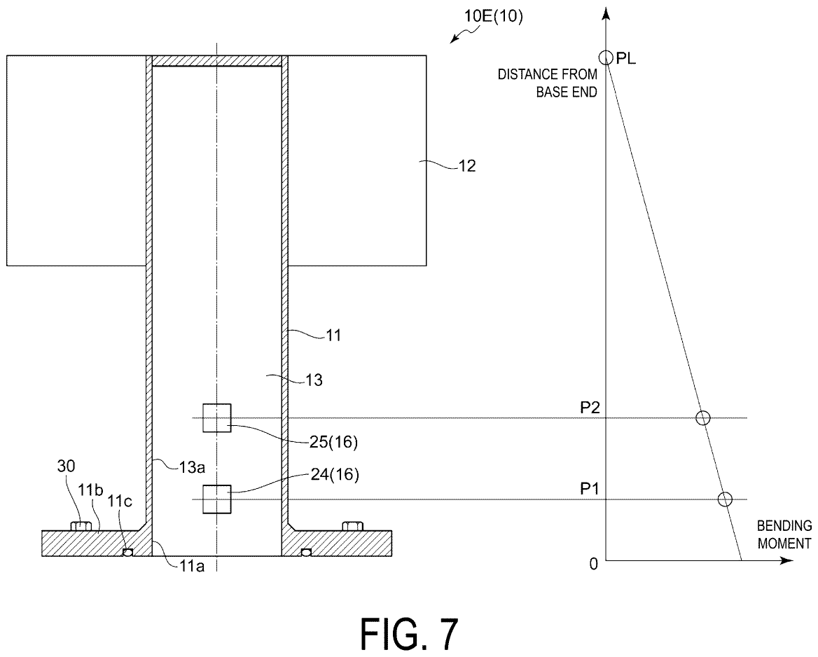

As illustrated in FIG. 7, in the stirring blade 10E according to a fifth embodiment, the one or more strain gauges 16 include at least two strain gauges 24 and 25, and the at least two strain gauges 24 and 25 are attached to different positions in an axial direction of the support 11. Other configurations are the same as those of the stirring blades 10A, 10B, 10C, and 10D according to any one of the first to fourth embodiments.

Preferably, the at least two gauges are attached on the same axis, and more preferably, are attached along a center line of the support 11.

Additionally, when the at least two gauges are triaxial strain gauges, as described in the fourth embodiment, the first strain measurement elements 161 of the respective gauges are preferably attached on the same axis, and more preferably attached along the center line of the support 11.

A (load point) of a load acting on the support 11 can be specified from a position where the strain gauge 16 is attached and a bending moment obtained from a strain amount thereof. When one strain gauge 16 is attached in the axial direction of the support 11, a bending moment can be obtained only from a position and a strain amount, and therefore, a load point cannot be accurately specified. Therefore, there is a risk that a load point is specified as being at a center of the blade 12 in a height direction even though the load point is located at a tip of the blade 12 in the height direction. On the other hand, in the stirring blade 10E according to the fifth embodiment, since the at least two strain gauges 24 and 25 are attached to different positions P1 and P2 in the axial direction of the support 11, a load point PL can be obtained from bending moments obtained from respective strain amounts at the different positions in the axial direction of the support 11. Therefore, the load point PL of the support 11 can be accurately specified, thereby enabling accurate strength evaluation of the stirring blade 10E.

### Sixth Embodiment

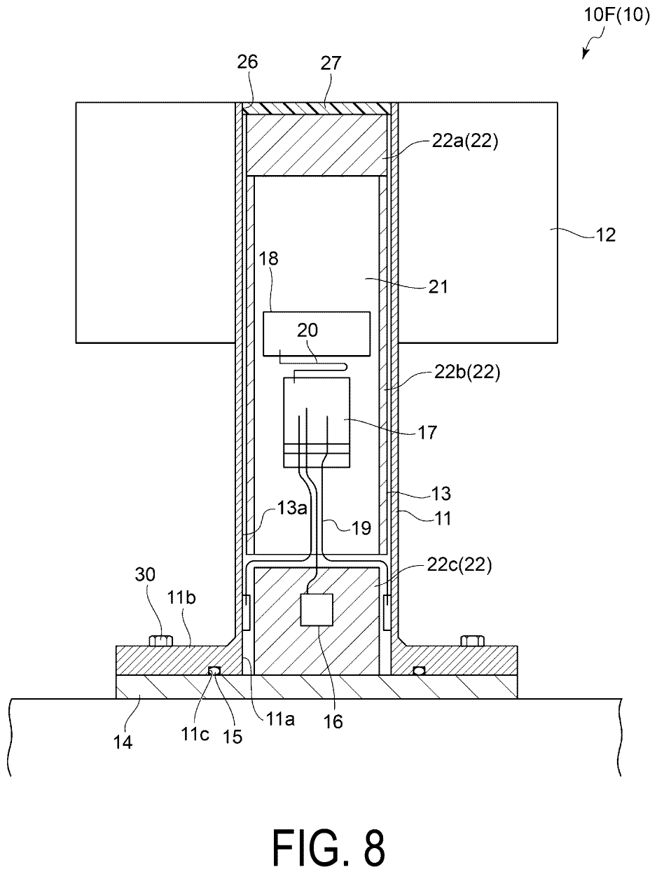

As illustrated in FIG. 8, in the stirring blade 10F according to a sixth embodiment, the data logger 17 is the data logger 17 of a wireless type that enables data communication by radio waves, a first opening 26 communicating with the first cavity portion 13 is formed at the support 11, and the first opening 26 is closed by a first lid 27 made of non-metal. Other configurations are the same as those of the stirring blades 10A, 10B, 10C, 10D, and 10E according to any one of the first to fifth embodiments.

The first opening 26 may be provided at any position as long as the position enables wireless communication between the data logger 17 of a wireless type installed inside the first cavity portion 13 and a receiver installed outside the support 11. In the example illustrated in FIG. 8, the first opening 26 is provided at one end portion (tip portion) of the support 11 from the viewpoint of the strength of the support 11, or the like, but the disclosure is not limited thereto, and the first opening 26 may be provided at a side surface of the support 11, for example. It is sufficient that the first lid 27 transmits radio waves of wireless communication, and the first lid 27 is made of, for example, a synthetic resin, but is not limited thereto. Further, the first lid 27 may be removable or may be fixed to the support 11 and cannot be removed, as long as the lid closes the first opening 26. Note that when the data logger 17 of a wireless type is used as the data logger 17 in the configuration including the vacuum double container 23 as in the stirring blade 10C according to the third embodiment, the lid 23b of the vacuum double container 23 is made of a material that transmits radio waves of wireless communication.

According to the stirring blade 10F according to the sixth embodiment, wireless communication is enabled between the data logger 17 of a wireless type installed at the first cavity portion 13 and the receiver installed outside the support 11. Thus, unlike the first to fifth embodiments in which the data logger 17 is taken out from the support 11 after operation of the stirring device 1 is finished and data accumulated in the data logger 17 is collected, the data accumulated in the data logger 17 can be acquired during stirring operation of the stirring device 1. This eliminates the need to remove the support 11 from the rotor shaft 3 in order to acquire the data from the data logger 17.

### Seventh Embodiment

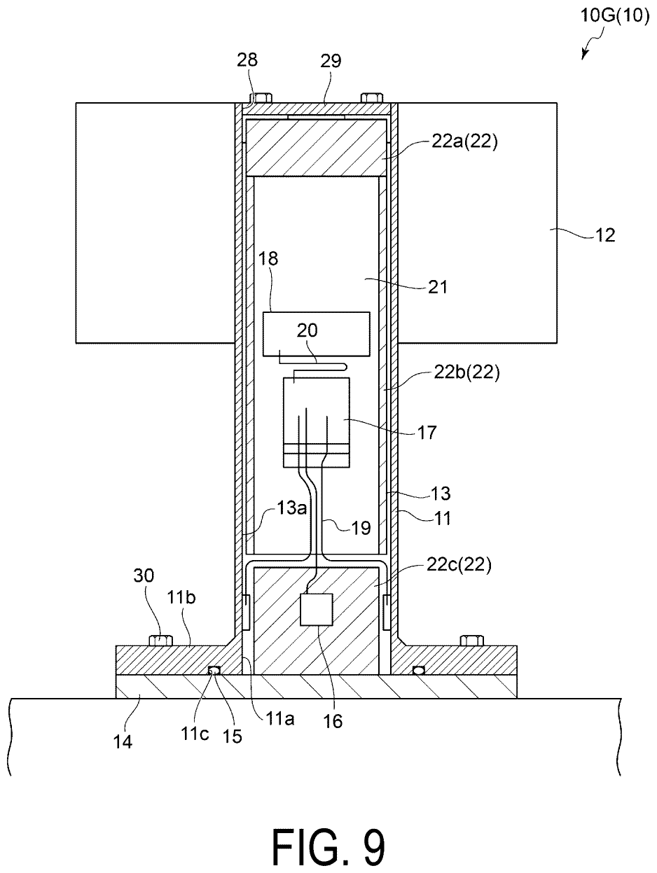

As illustrated in FIG. 9, in the stirring blade 10G according to a seventh embodiment, the power supply 18 is accommodated in the first cavity portion 13, a second opening 28 communicating with the first cavity portion 13 and having a size allowing the power supply 18 to be taken out is formed at the support 11, and the second opening 28 is closed by a second lid 29 capable of opening and closing the second opening 28. Other configurations are the same as those of the stirring blades 10A, 10B, 10C, 10D, 10E, and 10F according to any one of the first to sixth embodiments.

As long as the power supply 18 is accommodated in the first cavity portion 13, the power supply 18 may be accommodated in the second cavity portion 21 provided at the heat insulating material 22 fitted and accommodated in the first cavity portion 13, or may be accommodated in the vacuum double container 23 fitted into the second cavity portion 21.

The second opening 28 may be provided at any position as long as the second opening 28 communicates with the first cavity portion 13 and has a size that allows the power supply 18 to be taken out. In the example illustrated in FIG. 9, the second opening 28 is provided at one end portion of the support 11 from the viewpoint of the strength of the support 11, the viewpoint of ease of taking out the power supply 18, and the like, but the disclosure is not limited thereto, and the second opening 28 may be provided at a side surface of the support 11, for example. The second lid 29 may be made of metal or non-metal as long as the second lid 29 closes the second opening 28 so as to be openable and closable, but is made of non-metal when the second lid 29 also serves as the first lid 27 illustrated in the sixth embodiment.

According to the stirring blade 10G according to the seventh embodiment, the power supply 18 accommodated in the first cavity portion 13 can be taken out from the second opening 28 by the second lid 29 opening the second opening 28. Accordingly, the power supply 18 accommodated in the first cavity portion 13 can be taken out without removing the support 11 from the rotor shaft 3, and thus the power supply 18 accommodated in the first cavity portion 13 can be easily replaced.

### Eighth Embodiment

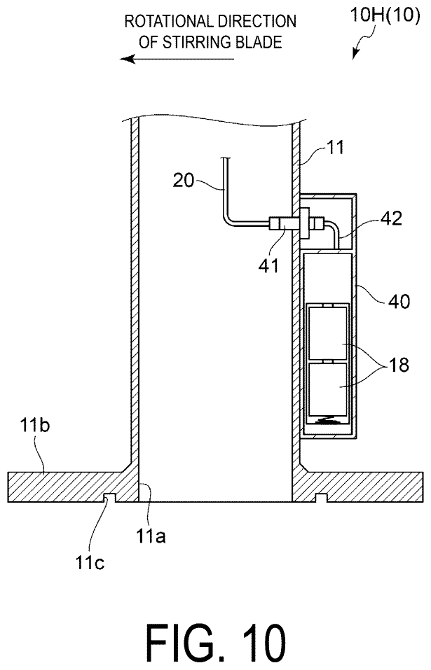

As illustrated in FIG. 10, in the stirring blade 10H according to an eighth embodiment, the power supply 18 is housed in a power supply box 40, and the power supply box 40 is fixed to the outside of the support 11. Other configurations are the same as those of the stirring blades 10A, 10B, 10C, 10D, 10E, 10F, and 10G according to any one of the first to sixth embodiments.

As long as the power supply box 40 houses the power supply 18 and is fixed to the outside of the support 11, a configuration may be adopted in which the power supply box 40 is fixed to the outside of the support 11 and cannot be removed from the support 11, or a configuration may be adopted in which the power supply box 40 can be removed from the outside of the support 11.

Further, as long as the power supply box 40 is fixed to the outside of the support 11, a configuration may be adopted in which the power supply box 40 is fixed to the outside of the support 11 as in the example illustrated in FIG. 10, or a configuration may be adopted in which the power supply box 40 is fixed to an outside of the rotor shaft 3.

In the case the configuration in which the power supply box 40 cannot be removed while the power supply box 40 is fixed to the outside of the support 11, the power supply 18 is to be directly taken out from the power supply box 40 to replace the power supply 18. On the other hand, in the case of the configuration in which the power supply box 40 can be removed from the outside of the support 11, the power supply 18 can be directly taken out from the power supply box 40 to replace the power supply 18, or the power supply box 40 can be removed from the outside of the support 11 to replace the power supply 18. Further, the power supply 18 can be replaced together with the power supply box 40.

In addition, in the stirring blade 10H according to the eighth embodiment, the support 11 includes a connection connector 41 penetrating from the outside of the support 11 to the first cavity portion 13, and the data logger 17 is electrically connected to the power supply 18 via the connection connector 41.

The electric wire 20 connected to the data logger 17 is connected to a terminal of the connection connector 41 close to the first cavity portion 13, and the power supply box 40 in which the power supply 18 is housed is connected to a terminal close to the outside of the support 11. The power supply box 40 connected to the terminal of the connection connector 41 close to the outside of the support 11 is connected to the terminal of the connection connector 41 close to the outside of the support 11 via an electric wire 42, but may be directly connected to the terminal of the connection connector 41 close to the outside of the support 11. The electric wire 20 connected to the power supply box 40 is detachably connected to the terminal of the connection connector 41 close to the outside of the support 11, but may be connected so as not to be detachable.

According to the stirring blade 10H according to the eighth embodiment, it is not necessary to remove the support 11 from the rotor shaft 3 as in the first to sixth embodiments, and thus the power supply 18 can be easily replaced.

Further, the support 11 includes the connection connector 41 penetrating from the outside of the support 11 to the first cavity portion 13, and the data logger 17 is electrically connected to the power supply 18 via the connection connector 41, so that the first cavity portion 13 can be kept airtight. In addition, when the electric wire 20 connected to the power supply box 40 is detachably connected to the terminal of the connection connector 41 close to the outside of the support 11, the data logger 17 can be electrically disconnected from the power supply 18 by removing the electric wire 20 connected to the power supply box 40 from the terminal of the connection connector 41 close to the outside of the support 11. Accordingly, the power supply box 40 can be removed from the outside of the support 11, and thus the power supply 18 housed in the power supply box 40 can be easily replaced. Further, since the power supply box 40 can be removed from the outside of the support 11, the power supply 18 can be replaced together with the power supply box 40.

### Ninth Embodiment

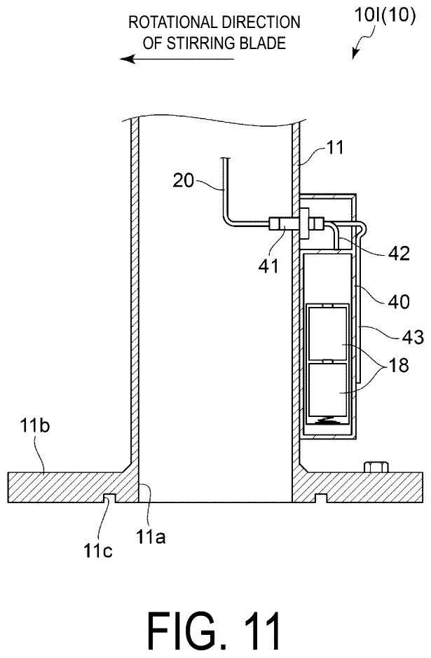

As illustrated in FIG. 11, in the stirring blade 10I according to a ninth embodiment, the data logger 17 is the data logger 17 of a wireless type enabling data communication by radio waves, an antenna line 43 connected to the connection connector 41 and extending to the outside of the support 11 is provided, and the data logger 17 is electrically connected to the antenna line 43 via the connection connector 41. Other configurations are the same as those of the stirring blade 10H according to the eighth embodiment.

A signal line connected to the data logger 17 is connected to a terminal of the connection connector 41 close to a first drive unit, and the antenna line 43 is connected to a terminal close to the outside of the support 11. The antenna line 43 is detachably connected to the terminal of the connection connector 41 close to the outside of the support 11, but may be connected so as not to be detachable.

In addition, in the stirring blade 10I according to the ninth embodiment, the antenna line 43 is provided so as to penetrate the power supply box 40 and extend along an outer surface of the power supply box 40.

According to the stirring blade 10I according to the ninth embodiment, the data logger 17 of a wireless type is electrically connected to the antenna line 43 via the connection connector 41, and thus wireless communication is enabled between the data logger 17 of the wireless type accommodated in the first cavity portion 13 and the receiver installed outside the support 11. Accordingly, data accumulated in the data logger 17 can be acquired without taking out the data logger 17 from the first cavity portion 13 formed inside the support 11.

Further, since the antenna line 43 is provided so as to penetrate the power supply box 40 and extend along the outer surface of the power supply box 40, it is possible to improve communication quality between the data logger 17 of the wireless type accommodated in the first cavity portion 13 and the receiver installed outside the support 11.

### Tenth Embodiment

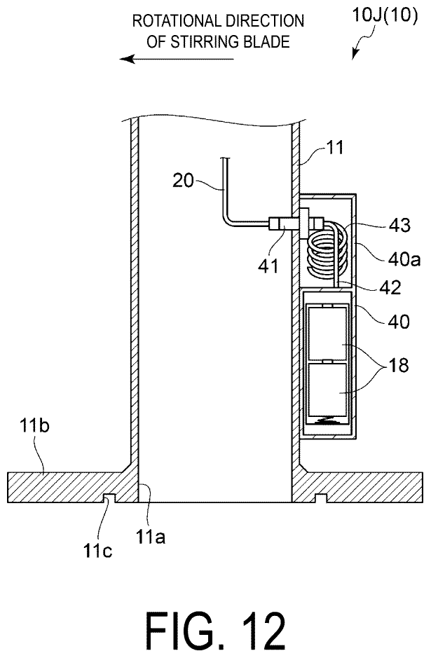

As illustrated in FIG. 12, in the stirring blade 10J according to a tenth embodiment, at least one part 40a of the power supply box 40 is made of non-metal, and the antenna line 43 is accommodated in the power supply box 40.

Other configurations are the same as those of the stirring blade 10I according to the ninth embodiment.

The at least one part 40a, which is made of non-metal, of the power supply box 40 is a portion in which the antenna line 43 is accommodated, and the entire power supply box 40 may be made of non-metal.

According to the stirring blade 10J according to the tenth embodiment, since the antenna line 43 is accommodated in the power supply box 40, the contents do not hit the antenna line 43 while the contents are stirred, and thus, a risk of disconnection of the antenna line 43 can be reduced.

### Eleventh Embodiment

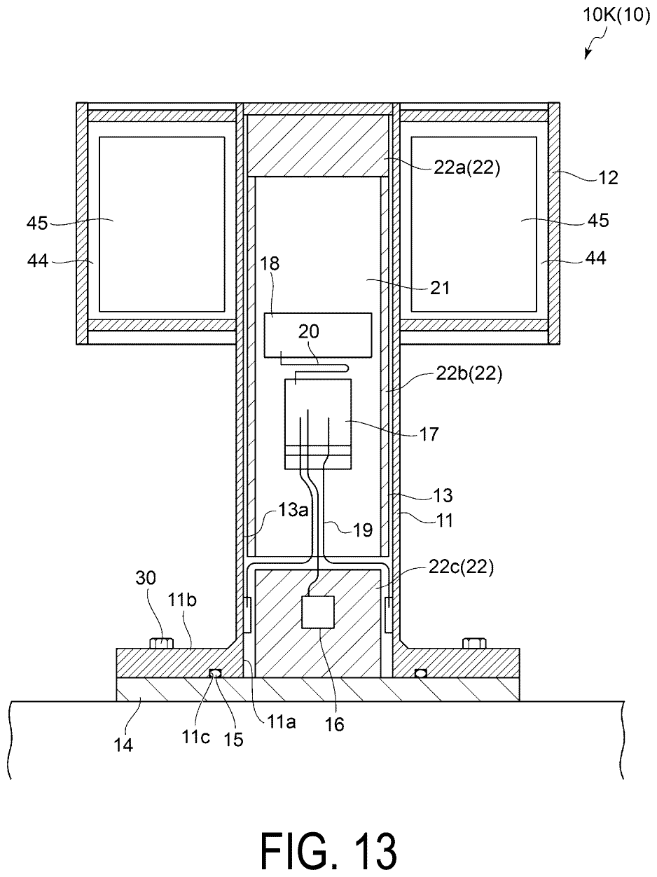

As illustrated in FIG. 13, in the stirring blade 10K according to an eleventh embodiment, the blade 12 includes a third cavity portion 44 capable of accommodating a power supply 45 therein, and the power supply 45 is accommodated in the third cavity portion 44. Other configurations are the same as those of the stirring blades 10A, 10B, 10C, 10D, 10E, 10F, 10G, 10H, 10I, and 10J according to any one of the first to tenth embodiments.

The power supply 45 accommodated in the third cavity portion 44 is a power supply capable of supplying power to the data logger 17, and, for example, supplies power to the data logger 17 together with the power supply 18 installed inside the support 11 or the power supply 18 installed outside the support 11 other than the third cavity portion 44, but it may also be possible that only the power supply 45 accommodated in the third cavity portion 44 is used as a power supply source of the data logger 17. Note that when the power supply 45 accommodated in the third cavity portion 44 is configured with a plurality of batteries, the plurality of batteries are connected in parallel to each other to provide a supply voltage to the data logger 17.

According to the stirring blade 10K according to the eleventh embodiment, by accommodating the power supply 45 in the third cavity portion 44 provided inside the blade 12, the third cavity portion 44 can be utilized. In addition, by supplying power to the data logger 17 from the power supply 45 accommodated in the third cavity portion 44, a decrease in remaining power of the power supply 18 installed inside the support 11 or outside the support 11 is reduced, and a replacement frequency of the power supply 18 can be reduced.

### Configuration of Stirring Device According to One Embodiment

Next, a configuration of the stirring device 1 in which at least one of the stirring blade 10F, 10I, or 10J according to the sixth embodiment, the ninth embodiment, or the tenth embodiment is fixed to the rotor shaft 3 will be described.

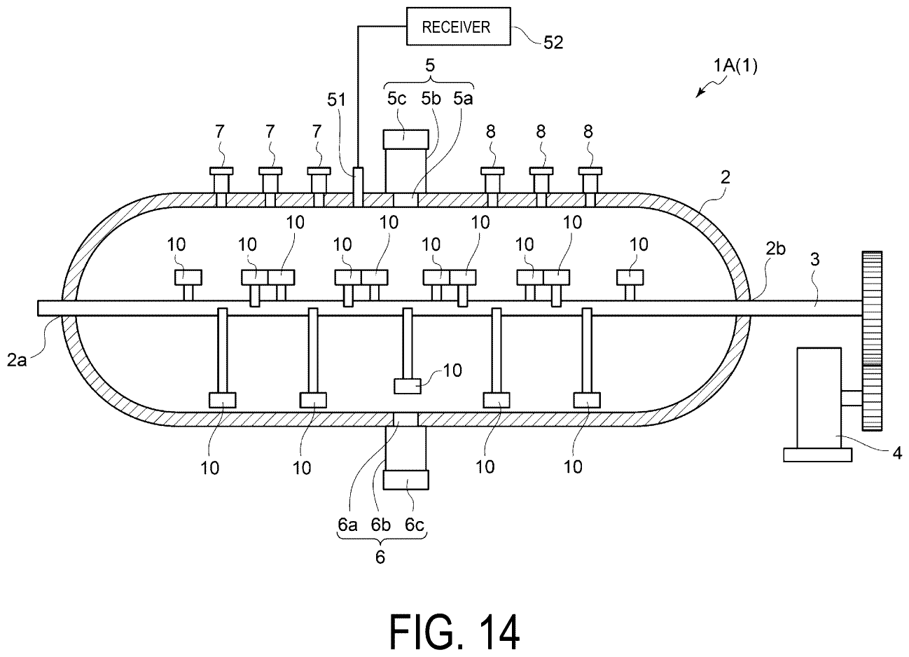

As illustrated in FIG. 14, in a stirring device 1A according to one embodiment, the stirring container 2 includes a radio relay antenna 51 penetrating an inside and an outside thereof. The radio relay antenna 51 is installed at a position suitable for communication with the data logger 17 of a wireless type accommodated in the first cavity portion 13 formed inside the support 11 of the one or more stirring blades 10.

According to the stirring device 1A according to the one embodiment, by the radio relay antenna 51 relaying data transmitted from the data logger 17 of a wireless type, a receiver 52 can acquire data recorded in the data logger 17. In this manner, by the relaying by the radio relay antenna 51, wireless communication is enabled between the data logger 17 of w wireless type and the receiver 52, and data acquisition during stirring operation of the stirring device 1 is enabled.

### Configuration of Stirring Device According to One Embodiment

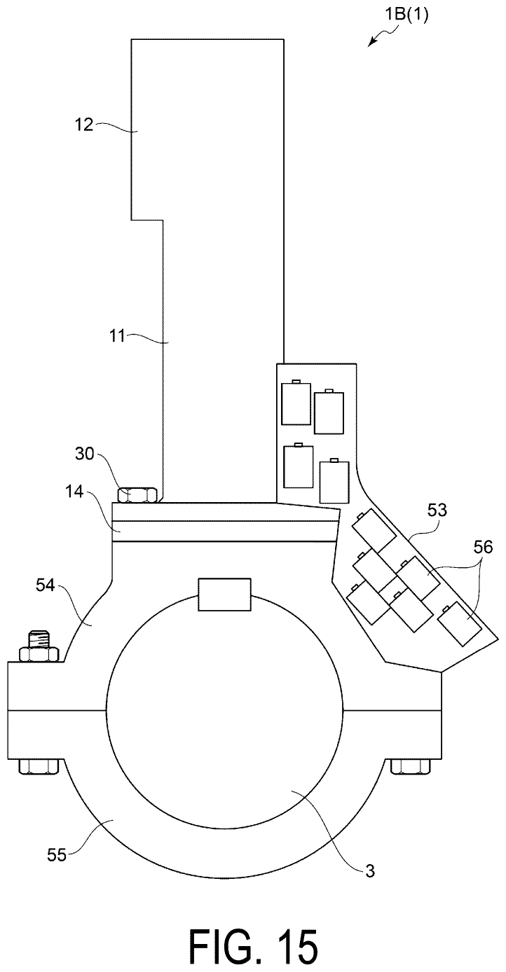

As illustrated in FIG. 15, in a stirring device 1B according to one embodiment, a power supply box 53 is fixed to the support 11 or the rotor shaft 3 so that the power supply box 53 is located behind the support 11 of one or more stirring blades 10L in a rotational direction of the one or more stirring blades 10L when the one or more stirring blades 10L rotate.

For example, when the stirring blade 10L is fixed to the rotor shaft 3 by a pair of sleeves 54 and 55, the power supply box 53 is provided across the stirring blade 10L (support 11) and the sleeve 54 on the stirring blade side of the pair of sleeves 54 and 55. The power supply box 53 is provided at a position behind the support 11 when the stirring blade 10 rotates. The power supply box 53 is narrower than a width of the support 11 in a direction orthogonal to a direction of rotation of the stirring blade 10 so that a stirring material does not directly hit the power supply box 53 when the stirring blade 10L rotates. A power supply 56 housed in the power supply box 53 is, for example, a large number of batteries, and a plurality of batteries are connected in parallel to each other to provide a supply voltage to the data logger 17.

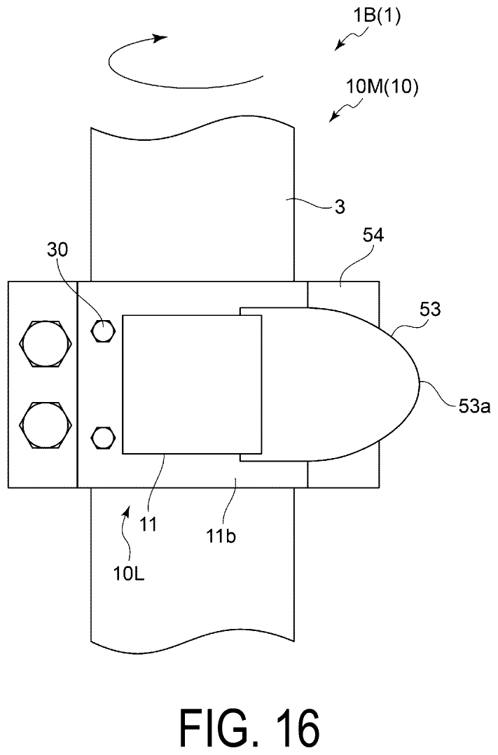

Additionally, as illustrated in FIG. 16, in the stirring device 1B according to the one embodiment, the power supply box 53 includes a curved surface 53a at at least a part of an outer surface thereof. The curved surface 53a prevents the power supply box 53 from interfering with stirring of the stirring material when the stirring blade 10L stirs the stirring material, and is formed so as to be gradually narrower than the width of the support 11 in a direction orthogonal to the rotational direction of the stirring blade 10L, for example.

Further, as long as the power supply box 53 does not interfere with the stirring of the stirring material when the stirring blade 10L stirs the stirring material, the disclosure is not limited to this, and a streamline shape having a curved surface in a part may be used, or an R shape in which a region to be a ridge line is a curved surface may be used.

According to the stirring device 1B of the one embodiment, contents while the contents are stirred are less likely to hit the power supply box 53, and a risk of damage to the power supply box 53 can be reduced. Further, since the power supply box 53 includes the curved surface 53a at at least a part of the outer surface thereof, the contents while the contents are stirred flow along at least a part of the outer surface of the power supply box 53, and the risk of damage to the power supply box 53 can be reduced.

The present invention is not limited to the embodiments described above, and also includes modification aspects of the above-described embodiments as well as appropriate combinations of these aspects.

The content described in the above embodiments can be understood as follows, for example.
[1] The stirring blade 10A according to one aspect is the stirring blade 10 including
the support 11, and
the blade 12 provided at the support 11,
the support 11 being the cylindrical support 11 having the first cavity portion 13 formed inside thereof, the stirring blade including
the one or more strain gauges 16 attached to the inner surface 13a defining the first cavity portion 13, and
the data logger 17 installed inside the first cavity portion 13 and electrically connected to each of the one or more strain gauges 16.

According to such a configuration, since the one or more strain gauges 16 attached to the inner surface 13a defining the first cavity portion 13 are electrically connected to the data logger 17 installed inside the first cavity portion 13, the lead wire 19 electrically connecting the strain gauge 16 to the data logger 17 is accommodated in the first cavity portion 13. This prevents the contents from hitting the lead wire 19 while the contents are stirred, and thus the risk of disconnection of the lead wire 19 can be reduced. Further, since the data logger 17 can be taken out from the first cavity portion 13 by removing the support 11 from the rotor shaft 3, a change in the electric resistance or a strain amount obtained by converting the change in the electric resistance can be acquired from the data logger 17 taken out. From the change in the electric resistance or the strain amount obtained by converting the change in the electric resistance taken out in this manner, the strain amount generated in the stirring blade 10A (support 11) while the contents are stirred can be considered. Then, the load acting on the stirring blade 10A (support 11) while the contents are stirred can be calculated from the strain amount.
[2] The stirring blade 10B according to a different aspect is the stirring blade according to [1], including the heat insulating material 22 that is provided with the second cavity portion 21 in which the data logger 17 is accommodated, and is fitted and accommodated in the first cavity portion 13.

According to such a configuration, even when the stirring blade 10B is used in a high-temperature environment, for example, as in a case where the stirring container 2 is a hydrolysis reactor or a chemical reactor, the data logger 17 is accommodated in the second cavity portion 21 provided at the heat insulating material 22 fitted and accommodated in the first cavity portion 13, and thus the data logger 17 is protected from the high-temperature environment, and a change in the electric resistance along with deformation of the strain gauge 16 or a strain amount obtained by converting the change in the electric resistance can be recorded.
[3] The stirring blade 10C according to a different aspect is the stirring blade according to [2], including the vacuum double container 23 in which the data logger 17 is sealed and that is fitted and accommodated in the second cavity portion 21.

According to such a configuration, the heat insulation effect is higher than that of the stirring blade 10B of [2] by the heat insulation effect of the vacuum double container 23, and thus the data logger 17 can be protected even when the stirring blade 10C is used under a higher-temperature environment as compared with the stirring blade 10B of [2].
[4] The stirring blade 10D according to a different aspect is the stirring blade according to any one of [1] to [3], wherein
the one or more strain gauges 16 include
the first strain measurement element 161,
the second strain measurement element 162 provided along the direction orthogonal to the first strain measurement element 161, and
the third strain measurement element 163 provided along the direction of 45 degrees with respect to the first strain measurement element 161 and the second strain measurement element 162, and
the first strain measurement element 161 is attached along the axial direction of the support 11.

According to such a configuration, strain in the axial direction of the support 11 is measured by a change in the electric resistance of the first strain measurement element 161, and strain in the direction orthogonal to the axial direction of the support 11 is measured by a change in the electric resistance of the second strain measurement element 162. Then, strain in the direction of 45 degrees with respect to the axial direction of the support 11 and the direction orthogonal to the axial direction is measured by a change in the electric resistance of the third strain measurement element 163. Then, from these, the bending force on the support 11 and the torsional force on the support 11 can be calculated. This makes it possible to separate the vertical stress caused by the bending force on the support 11 and the shear stress caused by the torsional force, and to more accurately evaluate the strength of the support 11.
[5] The stirring blade 10E according to a different aspect is the stirring blade according to any one of [1] to [4], wherein
the one or more strain gauges 16 include the at least two strain gauges 24 and 25, and the at least two strain gauges 24 and 25 are attached to different positions of the support 11 in the axial direction.

According to such a configuration, the load point PL can be obtained from the bending moment obtained from the respective strain amounts at the different positions in the axial direction of the support 11. Therefore, the load point PL of the support 11 can be accurately specified, thereby enabling accurate strength evaluation of the stirring blade 10E.
[6] The stirring blade 10F according to a different aspect is the stirring blade according to any one of [1] to [5], wherein
the data logger 17 is the data logger 17 of a wireless type enabling data communication by radio waves, and
the first opening 26 communicating with the first cavity portion 13 is formed at the support 11, and the first opening 26 is closed by the first lid 27 made of non-metal.

According to such a configuration, wireless communication is enabled between the data logger 17 of the wireless type installed at the first cavity portion 13 and the receiver installed outside the support 11. Thus, unlike [1] to in which the data logger 17 is taken out from the support 11 after operation of the stirring device 1 is finished and data accumulated in the data logger 17 is collected, the data accumulated in the data logger 17 can be acquired during stirring operation of the stirring device 1. This eliminates the need to remove the support 11 from the rotor shaft 3 in order to acquire the data from the data logger 17.
[7] The stirring blade 10G according to a different aspect is the stirring blade according to any one of [1] to [6], wherein
the power supply 18 electrically connected to the data logger 17 is accommodated in the first cavity portion 13,
the second opening 28 communicating with the first cavity portion 13 and having a size allowing the power supply 18 to be taken out is formed at the support 11, and the second opening 28 is closed by the second lid 29 capable of opening and closing the second opening 28.

According to such a configuration, the power supply 18 accommodated in the first cavity portion 13 can be taken out from the second opening 28 by the second lid 29 opening the second opening 28. This allows the power supply 18 accommodated in the first cavity portion 13 to be easily replaced.
[8] The stirring blade 10H according to a different aspect is the stirring blade according to any one of [1] to [6], wherein
the power supply 18 electrically connected to the data logger 17 is housed in the power supply box 40, and the power supply box 40 is fixed to the outside of the support 11.

According to such a configuration, unlike [1] to [6], it is not necessary to remove the support 11 from the rotor shaft 3, and thus the power supply 18 can be easily replaced.
[9] The stirring blade 10H according to a different aspect is the stirring blade according to [8], wherein
the support 11 includes the connection connector 41 penetrating from the outside of the support 11 to the first cavity portion 13, and
the data logger 17 is electrically connected to the power supply 18 via the connection connector 41.

According to such a configuration, the first cavity portion 13 can be kept airtight.
[10] The stirring blade 10I according to a different aspect is the stirring blade according to [9], wherein
the data logger 17 is the data logger 17 of a wireless type enabling data communication by radio waves,
the antenna line 43 connected to the connection connector 41 and extending to the outside of the support 11 is provided, and
the data logger 17 is electrically connected to the antenna line 43 via the connection connector 41.

According to such a configuration, wireless communication is enabled between the data logger 17 of the wireless type accommodated in the first cavity portion 13 and the receiver installed outside the support 11. Accordingly, data accumulated in the data logger 17 can be acquired without taking out the data logger 17 from the first cavity portion 13 formed inside the support 11.
[11] The stirring blade 10I according to a different aspect is the stirring blade according to [10], wherein the antenna line 43 is provided so as to penetrate the power supply box
40 and extend along the outer surface of the power supply box 40.

According to such a configuration, it is possible to improve the communication quality between the data logger 17 of a wireless type accommodated in the first cavity portion 13 and the receiver installed outside the support 11.
[12] The stirring blade 10J according to a different aspect is the stirring blade according to [10], wherein
at least a part of the power supply box 40 is made of non-metal, and the antenna line 43 is accommodated in the power supply box 40.

According to such a configuration, the contents do not hit the antenna line 43 while the contents are stirred, and thus the risk of disconnection of the antenna line 43 can be reduced.
[13] The stirring blade 10K according to a different aspect is the stirring blade according to any one of [1] to [10], wherein
the blade 12 includes the third hollow portion 44 capable of accommodating the power supply 45 electrically connected to the data logger 17 therein, and
the power supply 45 is accommodated in the third cavity portion 44.

According to such a configuration, the third cavity portion 44 can be utilized. In addition, by supplying power to the data logger 17 from the power supply 45 accommodated in the third cavity portion 44, a decrease in remaining power of the power supply 18 installed inside the support 11 or outside the support 11 is reduced, and the replacement frequency of the power supply 18 can be reduced.

The stirring device 1A according to an aspect of [14] includes
the rotor shaft 3 to which the support 11 of the one or more stirring blades 10F, 10I, and 10J according to any one of [6], and [10] to [12] are fixed, and
the stirring container 2 in which the one or more stirring blades 10F, 10I, and 10J are rotatably accommodated together with the rotor shaft 3, and
the stirring container 2 includes the radio relay antenna 51 penetrating the inside and the outside thereof.

According to such a configuration, by the radio relay antenna 51 relaying data transmitted from the data logger 17 of a wireless type, the receiver 52 can acquire data recorded in the data logger 17. In this manner, by the relaying by the radio relay antenna 51, wireless communication between the data logger 17 of the wireless type and the receiver 52 is enabled, and data acquisition during the stirring operation of the stirring device 1 is enabled.

The stirring device 1B according to an aspect of [15] includes
the rotor shaft 3 to which the support 11 of the one or more stirring blades 10H according to [8] described above are fixed, and
the stirring container 2 in which the one or more stirring blades 10 are rotatably accommodated together with the rotor shaft 3, wherein
the power supply box 53 is fixed to the support 11 or the rotor shaft 3 so that the power supply box 53 is located behind the support 11 of the one or more stirring blades 10 in the rotational direction of the one or more stirring blades 10H when the one or more stirring blades 10 rotate.

According to such a configuration, the contents are less likely to hit the power supply box 53 while the contents are stirred, and the risk of damage to the power supply box 53 can be reduced.

The stirring device 1 according to an aspect of [16] is the stirring device 1 according to [15], wherein
the power supply box 53 includes the curved surface 53a at at least a part of the outer surface thereof.

According to such a configuration, the contents flow along at least a part of the outer surface 53a of the power supply box 53 while the contents are stirred, and the risk of damage to the power supply box 53 can be reduced.

### REFERENCE SIGNS LIST

1, 1A, 1B Stirring device
2 Stirring container
2a, 2b End portion
2c Inner wall surface
3 Rotor shaft
4 Motor
5 Feed port
5a Feed hole
5b Feed cylinder
5c Opening/closing member
6 Discharge port
6a Discharge hole
6b Discharge cylinder
6c Opening/closing member
7 Supply port
8 Exhaust port
10, 10A to 10L Stirring blade
11 Support
11a Opening
11b Flange
11c Groove
12 Blade
13 First cavity portion
13a Inner surface
14 Lid member
15 O-ring
16 Strain gauge
161 First strain measurement element
162 Second strain measurement element
163 Third strain measurement element
17 Data logger
18 Power supply
19 Lead wire
20 Electric wire
21 Second cavity portion
22 Heat insulating material
22a, 22b, 22c Block
23 Vacuum double container
23a Container
23b Lid
24, 25 Strain gauge
26 First opening
27 First lid
28 Second opening
29 Second lid
30 Fastening member
40 Power supply box
41 Connection connector
42 Electric wire
43 Antenna line
44 Third cavity portion
45 Power supply
51 Radio relay antenna
52 Receiver
53 Power supply box
53a Curved surface
54, 55 Sleeve
56 Power supply

1. A stirring blade including
a support, and
a blade provided at the support,
the support being a cylindrical support having a first cavity portion formed inside thereof, the stirring blade comprising:
one or more strain gauges attached to an inner surface defining the first cavity portion; and
a data logger installed inside the first cavity portion and electrically connected to each of the one or more strain gauges.

2. The stirring blade according to claim 1, comprising a heat insulating material that is provided with a second cavity portion in which the data logger is accommodated, and is fitted and accommodated in the first cavity portion.

3. The stirring blade according to claim 2, comprising a vacuum double container in which the data logger is sealed, and that is fitted and accommodated in the second cavity portion.

4. The stirring blade according to claim 1, wherein
the one or more strain gauges include
a first strain measurement element,
a second strain measurement element provided along a direction orthogonal to the first strain measurement element, and
a third strain measurement element provided along a direction of 45 degrees with respect to the first strain measurement element and the second strain measurement element, and
the first strain measurement element is attached along an axial direction of the support.

5. The stirring blade according to claim 1, wherein
the one or more strain gauges include at least two strain gauges, and the at least two strain gauges are attached to different positions in the axial direction of the support.

6. The stirring blade according claim 1, wherein
the data logger is a data logger of a wireless type that enables data communication by a radio wave, and
a first opening that communicates with the first cavity portion is formed at the support, and the first opening is closed by a first lid made of non-metal.

7. The stirring blade according to claim 1, wherein
a power supply electrically connected to the data logger is accommodated in the first cavity portion,
a second opening that communicates with the first cavity portion and has a size that allows the power supply to be taken out is formed at the support, and the second opening is closed by a second lid that is allowed to open and close the second opening.

8. The stirring blade according to claim 1, wherein
the power supply electrically connected to the data logger is housed in a power supply box, and the power supply box is fixed to an outside of the support.

9. The stirring blade according to claim 8, wherein
the support includes a connection connector that penetrates from the outside of the support to the first cavity portion, and
the data logger is electrically connected to the power supply via the connection connector.

10. The stirring blade according to claim 9, wherein
the data logger is a data logger of a wireless type that enables data communication by a radio wave,
an antenna line that is connected to the connection connector and extends to the outside of the support is provided, and
the data logger is electrically connected to the antenna line via the connection connector.

11. The stirring blade according to claim 10, wherein
the antenna line is provided so as to penetrate the power supply box and extend along an outer surface of the power supply box.

12. The stirring blade according to claim 10, wherein
at least a part of the power supply box is made of non-metal, and the antenna line is accommodated in the power supply box.

13. The stirring blade according to claim 1, wherein
the blade includes a third cavity portion that is allowed to accommodate a power supply electrically connected to the data logger inside thereof, and
the power supply is accommodated in the third cavity portion.

14. A stirring device, comprising:
a rotor shaft to which the support of the one or more stirring blades according to claim 6 is fixed; and
a stirring container in which the one or more stirring blades are rotatably accommodated together with the rotor shaft, wherein
the stirring container includes a radio relay antenna that penetrates an inside and an outside thereof.

15. A stirring device, comprising:
a rotor shaft to which the support of the one or more stirring blades according to claim 8 are fixed; and
a stirring container in which the one or more stirring blades are rotatably accommodated together with the rotor shaft, wherein
the power supply box is fixed to the support or the rotor shaft so that the power supply box is located behind the support of the one or more stirring blades in a rotational direction of the one or more stirring blades when the one or more stirring blades rotate.

16. The stirring device according to claim 15, wherein
the power supply box includes a curved surface at at least a part of an outer surface thereof.
